(19) United States
(12) Patent Application Publication
(10) Pub. No.: US 2025/0240653 A1
(43) Pub. Date: Jul. 24, 2025

(54) COMMUNICATION METHOD AND COMMUNICATION APPARATUS

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/703,567

(22) PCT Filed: Oct. 22, 2021
(86) PCT No.: PCT/CN2021/125754

§ 371 Date: Apr. 22, 2024

(51) Int. Cl. H04W 24/08; H04W 24/10; H04W 84/12

(52) U.S. Cl. CPC H04W 24/08; H04W 24/10; H04W 84/12

(57) ABSTRACT

The present disclosure provides communication methods and communication apparatuses. The communication method includes: determining a trigger frame, where the trigger frame includes information indicating a receiver of a wireless local area network (WLAN) sensing measurement feeding back a result of at least one sensing measurement event; and sending the trigger frame.

### CROSS-REFERENCE TO RELATED APPLICATION

The present application is a U.S. National Stage of International Application No. PCT/CN2021/125754, filed on Oct. 22, 2021, the contents of which are incorporated herein by reference in their entirety for all purposes.

### TECHNICAL FIELD

The present disclosure relates to the field of wireless communication, and more specifically, to communication methods and communication apparatuses applicable to wireless local area network sensing.

### BACKGROUND

The Wireless Local Area Network (WLAN) is characterized by flexibility, mobility and low cost. With the development of communication technology and the growth of user needs, research on WLAN applications is gradually deepening. For example, WLAN sensing is currently being investigated, and its main application scenarios are: location discovery in dense environments (home and corporate environments), proximity detection, presence detection, etc.

### SUMMARY

Aspects of the present disclosure will solve at least the above problems and/or disadvantages. Various embodiments of the present disclosure provide the following technical solutions.

According to an example embodiment of the present disclosure, a communication method is provided. The communication method can be performed by a transmitter of a wireless local area network sensing measurement, and includes: determining a trigger frame, where the trigger frame includes information indicating a receiver of the wireless local area network sensing measurement which feeds back a result of at least one sensing measurement event; and sending the trigger frame.

According to an example embodiment of the present disclosure, a communication method is provided. The communication method can be performed by a receiver of a wireless local area network sensing measurement, and includes: receiving a trigger frame from a transmitter of the wireless local area network sensing measurement. Where the trigger frame includes information indicating the receiver which feeds back a result of at least one sensing measurement event; and feeding back the result of the at least one sensing measurement event based on the trigger frame.

According to an example embodiment of the present disclosure, a communication apparatus is provided. The communication apparatus can be applied to a transmitter of a wireless local area network sensing measurement, and includes: a processing module, configured to determine a trigger frame, where the trigger frame includes information indicating a receiver of the wireless local area network sensing measurement which feeds back a result of at least one sensing measurement event. And the communication apparatus further includes a transceiving module, configured to send the trigger frame.

According to an example embodiment of the present disclosure, a communication apparatus is provided. The communication apparatus can be applied to a receiver of a wireless local area network sensing measurement, and includes: a transceiving module, configured to receive a trigger frame from a transmitter of the wireless local area network sensing measurement, where the trigger frame includes information indicating the receiver of the wireless local area network sensing measurement which feeds back a result of at least one sensing measurement event. And the communication apparatus further includes a processing module, configured to control to feed back the result of the at least one sensing measurement event based on the trigger frame.

According to an example embodiment of the present disclosure, an electronic device is provided. The electronic device includes a memory, a processor and a computer program stored in the memory and operable on the processor. The processor, when executing the computer program, implements the method as described above.

According to an example embodiment of the present disclosure, a computer-readable storage medium is provided. A computer program is stored on the computer-readable storage medium. The computer program, when executed by a processor, implements the method as described above.

### BRIEF DESCRIPTION OF DRAWINGS

The above and other features of embodiments of the present disclosure will be more apparent by describing in detail example embodiments of the present disclosure with reference to the accompanying drawings.

FIGS. 1A-1C are exemplary diagrams illustrating WLAN sensing.

FIG. 2 is a flowchart illustrating a communication method according to an embodiment.

FIG. 3 is a flowchart illustrating another communication method according to an embodiment.

FIG. 4 is a block diagram illustrating a communication apparatus according to an embodiment.

### DETAILED DESCRIPTION

The following description with reference to the accompanying drawings is provided to help a comprehensive understanding of various embodiments of the present disclosure as defined by the appended claims and their equivalents. Various embodiments of the present disclosure include various specific details, which are to be considered as exemplary only. In addition, for the sake of clarity and conciseness, descriptions of well-known technologies, functions and configurations may be omitted.

The terms and words used in the present disclosure are not limited to written meanings, but are only used by inventors to enable a clear and consistent understanding of the present disclosure. Therefore, for those skilled in the art, the description of various embodiments of the present disclosure is provided for illustrative purposes only, and not for limiting purposes.

It should be understood that singular forms “a”, “an”, “said” and “the” used herein may also include plural forms unless the context clearly indicates otherwise. It should be further understood that the word “including” used in the present disclosure refers to a presence of the described features, integers, steps, operations, elements and/or components, but does not exclude a presence or addition of one or more other features, integers, steps, operations, elements, components and/or groups thereof.

It will be understood that although terms “first”, “second” and the like may be used herein to describe various elements, these elements should not be limited by these terms. These terms are only used to distinguish one element from another. Therefore, a first element discussed below may be referred to as a second element without departing from the teaching of example embodiments.

It should be understood that when an element is referred to as “connected” or “coupled” to another element, it may be directly connected or coupled to the other element, or there may be intermediate elements. Furthermore, “connected” or “coupled” as used herein may include wireless connection or wireless coupling. Term “and/or” or expression “at least one/at least one of . . . ” as used herein includes any and all combinations of one or more of items listed therein.

Unless otherwise defined, all terms (including technical terms and scientific terms) used herein have the same meaning as commonly understood by ordinary technicians in the field to which the present disclosure belongs.

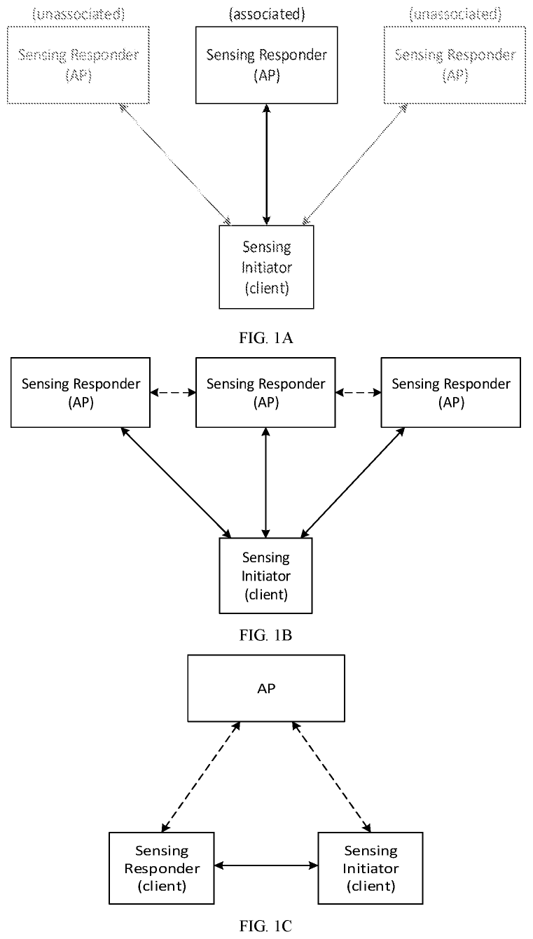

FIGS. 1A-1C are exemplary manners illustrating WLAN sensing.

A process of WLAN sensing can be as follows: an initiator initiates WLAN sensing (e.g., initiates a WLAN sensing session), and there may be multiple responders responding to the WLAN sensing. The specific approaches can be shown as FIGS. 1A, 1B, and 1C.

Referring to FIG. 1A, when a WLAN sensing initiator (e.g., a client) initiates WLAN sensing, multiple associated or unassociated WLAN sensing responders, e.g., three APs (access points), may respond. “Associated” may mean that an initiator and a responder have established an associated connection for communication, and “unassociated” may mean that an initiator and a responder have not established an associated connection for communication.

As an example, a client may include, but is not limited to: a cellular phone, a smart phone, a wearable device, a computer, a personal digital assistant (PDA), a personal communication system (PCS) device, a personal information manager (PIM), a personal navigation device (PND), a global positioning system, a multimedia device, an Internet of Things (IoT) device, and the like.

The AP may be a wireless network switch used in a wireless network and may also be an access device of a wireless network. The AP may include software applications and/or circuits, so that other types of nodes in the wireless network can communicate with outside and inside of the wireless network through the AP. As an example, the AP may be a terminal device or a network device equipped with a wireless fidelity (Wi-Fi) chip.

FIG. 1B is similar to FIG. 1A, but in FIG. 1B, the responders (APs) can communicate with each other.

Referring to FIG. 1C, both the WLAN sensing initiator and the WLAN sensing responder can be clients, and they may communicate with each other by connecting to a same AP.

Although as illustrated in FIGS. 1A, 1B, and 1C, the client serves as the initiator and the AP serves as the responder, the present disclosure is not limited thereto. For example, the AP may serve as the initiator and the client may serve as the responder. Furthermore, the numbers of initiators and responders are not limited to that shown in FIGS. 1A, 1B, and 1C.

A WLAN sensing session initiated by an initiator may include one or more of the following phases: a setup phase, a measurement phase, a reporting phase, and a termination phase.

In the setup phase, a sensing session is established, and operational parameters related with the sensing session are determined and exchanged between the devices. In the measurement phase, a sensing measurement may be performed. In the reporting phase, a result of the sensing measurement may be reported. In the termination phase, a device stops performing the measurement and terminates the sensing session.

The measurement phase (or called as “measurement process”) may contain multiple sensing measurement events. In each sensing measurement event, a sensing measurement can be performed between a transmitter and a receiver. The WLAN sensing initiator in FIGS. 1A-1C may be a participant in the sensing measurement event, for example, as a transmitter of the sensing measurement event. For another example, the WLAN sensing initiator may not be a participant in the sensing measurement event, e.g., the WLAN sensing initiator may not be a transmitter nor a receiver. That is, the sensing measurement event may be performed between WLAN sensing responders. In embodiments of the present disclosure, communication between the transmitter and the receiver is mainly investigated.

In the reporting phase, the transmitter may receive a report frame from the receiver, where the report frame may contain channel state information (CSI). In an embodiment of the present disclosure, the report frame may be delayed feedback, and the transmitter is required to trigger the delayed feedback report frame. For example, there may be two ways for the triggering. One triggering manner may be: sending poll frames one-to-one (e.g., sending a poll frame to each receiver), which wastes many resources. Another triggering manner may be: the transmitter sending a trigger frame, which may be one-to-one (e.g., one transmitter sending a trigger frame to one receiver) or one-to-many (e.g., one transmitter sending a trigger frame to multiple receivers), thereby saving unnecessary overhead. However, currently in this field, there is a lack of mechanisms to define such trigger frame.

In view of the foregoing, communication methods and communication apparatuses are provided according to the concepts of embodiments of the present disclosure, so as to address at least the above technical issues.

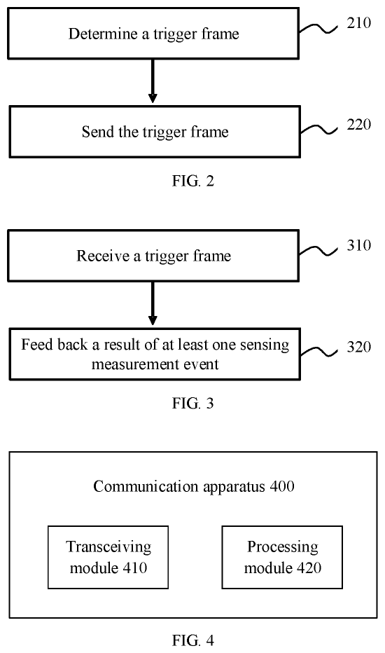

FIG. 2 is a flowchart illustrating a communication method according to an embodiment. The communication method shown in FIG. 2 may be applied to a transmitter of a WLAN sensing measurement. FIG. 2 includes steps 210 and 220.

Referring to FIG. 2, at step 210, a trigger frame can be determined. The trigger frame may include information indicating a receiver of the WLAN sensing measurement feeding back a result of at least one sensing measurement event.

In embodiments of the present disclosure, there may be various ways to determine the trigger frame, e.g., the trigger frame may be generated or configured based on at least one of the following: a channel state, a network condition, a load condition, a hardware capability of the transmitting/receiving device, a service type, and a relevant protocol provision; for which the embodiments of the present disclosure are not specifically limited. In embodiments of the present disclosure, the trigger frame may also be obtained from an external device, which is not limited in the embodiment of the present disclosure.

According to embodiments of the present disclosure, the feedback for one or more sensing measurement events may be indicated in the trigger frame. For example, the information in the trigger frame indicating that the receiver of the WLAN sensing measurement feeds back the result of the at least one sensing measurement event may include at least one of the following: a receiver identifier for each sensing measurement event; a sensing measurement process identifier corresponding to each sensing measurement event; a sensing measurement event identifier identifying each sensing measurement event; or a radio unit required to feed back a result of each sensing measurement event.

Each of these items are described in detail herein.

Since a receiver of a WLAN sensing measurement may participate in one or more sensing measurement events in one WLAN sensing measurement, a receiver identifier (receiver ID) in each of the one or more sensing measurement events may be included in the trigger frame. For example, the receiver identifier may include: an identifier (AID) for identifying that the receiver has established an association with the transmitter, and/or an identifier (UID) for identifying that the receiver has not established an association with the transmitter.

A WLAN sensing process may include one or more sensing measurement processes, and each sensing measurement process may include at least one sense measurement event. Therefore, to accurately identify the sensing measurement event, a sensing measurement process identifier (measurement process ID) corresponding to each of the at least one sensing measurement event may be included in the trigger frame. As an example, the trigger frame may include one or more sensing measurement process identifiers (measurement process IDs). In addition, a corresponding identifier may also exist for each sensing measurement event.

According to embodiments of the present disclosure, a radio unit (RU, also known as communication resource unit) required for feeding back each of the at least one sensing measurement event may be specified in the trigger frame. A size of a RU may be different for different receivers. By configuring the RU required for feeding back each of the at least one sensing measurement event in the trigger frame, the communication resources can be reasonably allocated, so that the receiver(s) can utilize the configured RU to feed back the corresponding sensing measurement event(s) and avoid interference between devices.

There is a correspondence between a receiver identifier, a sensing measurement process identifier, a sensing measurement event identifier, and a RU of each sensing measurement event included in the trigger frame. The trigger frame may include a plurality of sensing measurement process identifiers or a plurality of sensing measurement event identifiers, which correspond to different RUs or receiver identifiers.

For example, a sensing measurement process identifier may correspond to sensing measurement event identifier(s). For example, the sensing measurement event identifier identifying each sensing measurement event in the triggering frame may be expressed as “measurement process ID_measurement event ID”.

For example, a sensing measurement event identifier corresponds to a receiver identifier, where a receiver identifier may correspond to at least one sensing measurement event identifier. For example, when a receiver is participated in more than one sensing measurement events, the receiver identifier may correspond to more than one sensing measurement event identifiers, and the receiver identifier may be an AID and/or a UID.

According to embodiments of the present disclosure, since the receiver may participate in one or more sensing measurement events in a sensing measurement, the following is required to be included in the trigger frame.

A, a receiver identifier (receiver ID), e.g., an AID/UID, where the AID identifies that the receiver sets an association with the transmitter, and the UID identifies that the receiver does not set an association with the transmitter.

B, a measurement process ID.

C, a measurement event ID, where the measurement event ID and the AID/UID correspond to each other, and possibly one AID/UID corresponds to a plurality of measurement event IDs, indicating that the receiver feeds back results of the plurality of measurement events.

D, a RU required for feeding back each sensing measurement event, where a size of the RU may be different for different receivers.

However, it will be understood that it is not necessary to include all of the above items in the trigger frame. For example, when only one receiver is required to feed back one sensing measurement event, only the RU may be included in the trigger frame and the other identifiers may be omitted.

For example, as a descriptive embodiment only, information, included in the trigger frame, indicating that a receiver of a WLAN sensing measurement feeds back a result of at least one sensing measurement event is shown in Table 1 below. For example, the information may be included in a report subvariant field of the trigger frame, however the present disclosure is not limited thereto, and the information may be carried in any other form in the trigger frame.

TABLE 1
a report subvariant field of a trigger frame

| Information | Description |
|---|---|
| Receiver ID1 (AID) | Receiver 1 for feeding back sensing |
| | measurement event(s) |
| Measurement process ID1 | Measurement process 1 participated |
| | by receiver 1 |
| Measurement process | Sensing measurement event 11 of |
| ID1_measurement event ID11 | measurement process 1 |
| RU11 | RU11 for feeding back a result of |
| | sensing measurement event 11 |
| Measurement process | Sensing measurement event 12 of |
| ID1_measurement event ID12 | measurement process 1 |
| RU12 | RU12 for feeding back a result of |
| | sensing measurement event 11 |
| . . . | . . . |
| Measurement process ID2 | Measurement process 2 participated |
| | by receiver 1 |
| Measurement process | Sensing measurement event 21 of |
| ID2_measurement event ID21 | measurement process 2 |
| RU21 | RU21 for feeding back a result of |
| | sensing measurement event 11 |
| . . . | . . . |
| Receiver ID2 (UID) | Receiver 2 for feeding back |
| | sensing measurement event(s) |
| . . . | . . . |

In Table 1, the identifiers of the two receivers are shown, and specifically, it is shown that one of the two receiver identifiers correspond to two sensing measurement process identifiers as well as that each sensing measurement process identifier corresponds to the sensing measurement event identifiers and the RUs. However, it will be appreciated that the information shown in Table 1 is only exemplary and the present disclosure is not limited thereto. For example, the triggering frame may include more or fewer receiver identifiers, and sensing measurement process identifier(s), sensing measurement event identifier(s), and RU(s) corresponding to each receiver identifier may be changed variously based on an actual measurement report that need to be fed back.

With continued reference to FIG. 2, at step 220, the trigger frame can be sent. For example, the trigger frame determined at step 210 may be sent to at least one receiver, so as to request sending a sensing measurement event feedback result. Sending the trigger frame directly is illustrated in step 220, and such direct sending may save signaling, where the feedback result is sent in a delayed feedback manner which is negotiated between the transmitter and the receiver.

However, the present disclosure is not limited thereto. For example, a poll frame for waking up the receiver may be sent before sending the trigger frame. That is, the transmitter may send the poll frame first, and then send the trigger frame. In this manner, the corresponding receiver may be woken up first, so that the receiver can receive the trigger frame more accurately.

The communication method according to embodiments of the present disclosure is able to define a format of a trigger frame in the case of a delayed report frame, which facilitate a process of a WLAN sensing measurement.

FIG. 3 is a flowchart illustrating another communication method according to an embodiment. The communication method shown in FIG. 3 may be applied to a receiver of a WLAN sensing measurement. FIG. 3 includes steps 310 and 320.

Referring to FIG. 3, at step 310, a trigger frame is received from a transmitter of the WLAN sensing measurement. The trigger frame may include information indicating the receiver feeding back a result of at least one sensing measurement event.

According to embodiments of the present disclosure, the information indicating that the receiver feeds back the result of the at least one sensing measurement event may include at least one of the following: a receiver identifier for each sensing measurement event; a sensing measurement process identifier corresponding to each sensing measurement event; a sensing measurement event identifier identifying each sensing measurement event; or a radio unit required to feed back a result of each sensing measurement event.

The embodiments of the receiver identifier, the sense measurement process identifier, the sense measurement event identifier, and the radio unit described herein with reference to step 210 of FIG. 2 and Table 1 may be applied thereto, and repetitive descriptions are omitted herein for brevity.

According to embodiment of the present disclosure, the receiver identifier may include an identifier for identifying that the receiver has established an association with the transmitter, and/or an identifier for identifying that the receiver has not established an association with the transmitter.

According to embodiment of the present disclosure, the sensing measurement event identifier may correspond to the receiver identifier, for example, one receiver identifier may correspond to at least one sensing measurement event identifier.

According to embodiment of the present disclosure, a size of each radio unit is different for different receivers.

According to embodiment of the present disclosure, the information may be included in a report subvariant field of the trigger frame.

At step 320, the result of the at least one sensing measurement event may be fed back based on the trigger frame. For example, the receiver may determine the sensing measurement event(s) to be fed back based on respective pieces of information defined in the trigger frame, and feed back the result to the transmitter by using the corresponding RU(s).

It will be appreciated that the communication method shown in FIG. 3 is only exemplary and the present disclosure is not limited thereto. For example, the communication method shown in FIG. 3 may further include: receiving a polling frame to be woken up before receiving the trigger frame.

Furthermore, feeding back the result of the at least one sensing measurement event at step 320 is accomplished within predetermined time, where the predetermined time is predefined during a WLAN sensing session setup process. For example, the feedback (reporting) process needs to be completed within a time range defined by the sensing session, where the defined time range can be obtained from a sensing session setup frame initiated by the initiator. The communication method according to embodiments of the present disclosure enables timely feedback of the result of the sensing measurement event(s) within the defined time range, while also reducing interference to other device(s).

FIG. 4 is a block diagram illustrating a communication apparatus according to embodiments. The communication apparatus 400 of FIG. 4 may include a processing module 420 and a transceiving module 410. In an embodiment of the present disclosure, the communication apparatus 400 illustrated in FIG. 4 may be applied to a transmitter of a WLAN sensing measurement; and in another embodiment of the present disclosure, the communication apparatus 400 illustrated in FIG. 4 may be applied to a receiver of a WLAN sensing measurement.

In the case where the communication apparatus 400 shown in FIG. 4 is applied to a transmitter of a WLAN sensing measurement, the processing module 420 may be configured to determine a trigger frame, where the trigger frame may include information indicating a receiver of a wireless local area network sensing measurement which feeds back a result of at least one sensing measurement event; and the transceiving module 410 may be configured to send the trigger frame. That is, the communication apparatus 400 shown in FIG. 4 may perform the communication method described with reference to FIG. 2, and the embodiments described above with respect to the various pieces of information included in the trigger frame may be applied herein, and repetitive descriptions are omitted here to avoid redundancy.

In the case where the communication apparatus 400 shown in FIG. 4 is applied to a receiver of a WLAN sensing measurement, the transceiving module 410 may be configured to receive a trigger frame from a transmitter of a wireless local area network sensing measurement, where the trigger frame comprises information indicating a receiver of the wireless local area network sensing measurement which feeds back a result of at least one sensing measurement event; and the processing module 420 may be configured to control to feed back the result of the at least one sensing measurement event based on the trigger frame. That is, the communication apparatus 400 shown in FIG. 4 may perform the communication method described with reference to FIG. 3, and the embodiments described above with respect to the various pieces of information included in the trigger frame may be applied herein, and repetitive descriptions are omitted here to avoid redundancy.

It will be appreciated that the communication apparatus 400 shown in FIG. 4 is merely exemplary and embodiments of the present disclosure are not limited thereto. For example, the communication apparatus 400 may include other modules, such as a memory and the like. Furthermore, modules in the communication apparatus 400 may be combined into more complex modules or may be divided into more separate modules.

The communication methods and communication apparatuses according to embodiments of the present disclosure can define a format of a trigger frame in case of a delayed report frame, such that a process of WLAN sensing measurement can be implemented.

Based on the same principle as the method provided by the embodiment of the present disclosure, the embodiment of the present disclosure further provides that the communication apparatus 400 can be an electronic device, which includes a processor and a memory; where the memory stores a machine-readable instruction (which may also be referred to as a “computer program”); and the processor is configured to execute the machine-readable instruction to implement the methods described with reference to FIGS. 2 and 3.

An embodiment of the present disclosure further provides a non-transitory computer-readable storage medium having a computer program stored thereon, which when executed by a processor implements the methods described with reference to FIGS. 2 and 3.

In an example embodiment, the processor may be a logic block, module and circuit for implementing or executing various examples described in connection with the present disclosure, for example, a central processing unit (CPU), a general-purpose processor, a digital signal processor (DSP), an application specific integrated circuit (ASIC), a field programmable gate array (FPGA) or other programmable logic devices, transistor logic devices, hardware components or any combination thereof. The processor can also be a combination that realizes computing functions, for example, including one or more microprocessor combinations, DSP and microprocessor combinations, etc.

In an example embodiment, the memory may be, for example, a read only memory (ROM), a random access memory (RAM), an electrically erasable programmable read only memory (EEPROM), a compact disc read only memory (CD-ROM) or other optical disc storage, optical disc storage (including compact disc, laser disc, optical disc, digital versatile disc, Blu-ray disc, etc.), magnetic disc storage medium or other magnetic storage devices, or any other medium that can be used to carry or store program codes in the form of instructions or data structures and can be accessed by a computer, but is not limited to this.

It should be understood that although the various steps in the flowchart of the accompanying drawings are shown sequentially as indicated by the arrows, the steps are not necessarily performed sequentially in the order indicated by the arrows. Unless explicitly stated herein, the execution of these steps is not strictly limited in order, and they can be executed in other orders. In addition, at least a part of the steps in the flowchart of the accompanying drawings may include a plurality of sub-steps or stages, which may not necessarily be completed at the same time, but may be executed at different times, and the execution order may not necessarily be sequential, but may be executed alternately or alternatively with other steps or at least a part of sub-steps or stages of other steps.

While the present disclosure has been shown and described with reference to certain embodiments of the present disclosure, those skilled in the art will appreciate that various changes in form and detail can be made without departing from the scope of the present disclosure. Therefore, the scope of the present disclosure should not be limited by the embodiments, but should be defined by the appended claims and their equivalents.

1. A communication method, performed by a transmitter of a wireless local area network sensing measurement, comprising:
determining a trigger frame, wherein the trigger frame comprises information indicating a receiver of the wireless local area network sensing measurement which feeds back a result of at least one sensing measurement event; and
sending the trigger frame.

2. The communication method according to claim 1, wherein the information comprises at least one of:
a receiver identifier for each sensing measurement event;
a sensing measurement process identifier corresponding to each sensing measurement event;
a sensing measurement event identifier identifying each sensing measurement event; or
a radio unit required to feed back a result of each sensing measurement event.

3. The communication method according to claim 2, wherein the receiver identifier comprises at least one of:
an identifier for identifying that the receiver has established an association with the transmitter, or
an identifier for identifying that the receiver has not established an association with the transmitter.

4. The communication method according to claim 2,
wherein the sensing measurement event identifier corresponds to the receiver identifier, and
wherein one receiver identifier corresponds to at least one sensing measurement event identifier.

5. The communication method according to claim 4, wherein a size of the radio unit is different for different receivers.

6. The communication method according to claim 1, further comprising:
sending a poll frame for waking up the receiver before sending the trigger frame.

7. The communication method according to claim 1, the information is comprised in a report subvariant field of the trigger frame.

8. A communication method, performed by a receiver of a wireless local area network sensing measurement, comprising:
receiving a trigger frame from a transmitter of the wireless local area network sensing measurement, wherein the trigger frame comprises information indicating the receiver which feeds back a result of at least one sensing measurement event; and
feeding back the result of the at least one sensing measurement event based on the trigger frame.

9. The communication method according to claim 8, wherein the information comprises at least one of:
a receiver identifier for each sensing measurement event;
a sensing measurement process identifier corresponding to each sensing measurement event;
a sensing measurement event identifier identifying each sensing measurement event; or
a radio unit required to feed back a result of each sensing measurement event.

10. The communication method according to claim 9, wherein the receiver identifier comprises at least one of:
an identifier for identifying that the receiver has established an association with the transmitter, or
an identifier for identifying that the receiver has not established an association with the transmitter.

11. The communication method according to claim 9,
wherein the sensing measurement event identifier corresponds to the receiver identifier, and
wherein one receiver identifier corresponds to at least one sensing measurement event identifier.

12. The communication method according to claim 11, wherein a size of the radio unit is different for different receivers.

13. The communication method according to claim 8, further comprising:
receiving a poll frame to be woken up before receiving the trigger frame.

14. The communication method according to claim 8, the information is comprised in a report subvariant field of the trigger frame.

15. The communication method according to claim 8, wherein feeding back the result of the at least one sensing measurement event is accomplished within predetermined time, and wherein the predetermined time is predefined during a wireless local area network sensing session setup process.

16-17. (canceled)

18. An electronic apparatus, comprising a memory, a processor and a computer program stored in the memory and executable on the processor, wherein the processor is configured to:
determine a trigger frame, wherein the trigger frame comprises information indicating a receiver of a wireless local area network sensing measurement which feeds back a result of at least one sensing measurement event; and
send the trigger frame.

19. (canceled)

20. The electronic apparatus according to claim 18, wherein the information comprises at least one of:
a receiver identifier for each sensing measurement event;
a sensing measurement process identifier corresponding to each sensing measurement event;
a sensing measurement event identifier identifying each sensing measurement event; or
a radio unit required to feed back a result of each sensing measurement event.

21. The electronic apparatus according to claim 18, wherein the processor is further configured to:
send a poll frame for waking up the receiver before sending the trigger frame.

22. An electronic apparatus, comprising a memory, a processor and a computer program stored in the memory and executable on the processor, wherein the processor, when executing the computer program, implements the method according to claim 8.

23. The electronic apparatus according to claim 22, wherein feeding back the result of the at least one sensing measurement event is accomplished within predetermined time, and wherein the predetermined time is predefined during a wireless local area network sensing session setup process.
